(19) United States
(12) Patent Application Publication
(10) Pub. No.: US 2024/0102866 A1
(43) Pub. Date: Mar. 28, 2024

(54) CHARACTERIZATION OF A RADIATION PULSE BY TIME-RESOLVED OPTICAL GATING

(71) Applicants: UNIVERSITE DE BOURGOGNE, DIJON (FR); CENTRE NATIONAL DE LA RECHERCHE SCIENTIFIQUE - CNRS -, PARIS (FR)

(72) Inventors: Pierre BEJOT, CHARBONNIÈRES (FR); Franck BILLARD, VILLY EN AUXOIS (FR); Edouard HERTZ, CHAUSSIN (FR)

(73) Assignees: UNIVERSITE DE BOURGOGNE, DIJON (FR); CENTRE NATIONAL DE LA RECHERCHE SCIENTIFIQUE - CNRS -, PARIS (FR)

(21) Appl. No.: 18/254,023

(22) PCT Filed: Sep. 24, 2021
(86) PCT No.: PCT/FR2021/051650

§ 371 Date: May 23, 2023

(30) Foreign Application Priority Data
Dec. 3, 2020 (FR) 2012605

(51) Int. Cl. G01J 11/00; G02B 5/20; H04N 23/12

(52) U.S. Cl. CPC G01J 11/00; G02B 5/20; H04N 23/12

(57) ABSTRACT

A system for characterizing a pulse of electromagnetic radiation by time-resolved optical gating, which includes an interference-forming device which is adapted for superimposing four parts of the pulse. The system also includes a matrix image sensor which selectively captures, based on two-photon absorptions, an interference pattern formed by the pulse. The system allows obtaining the pulse shape completely and accurately, and is particularly suitable for characterizing ultrashort pulses. Also, the two-photon absorption can be produced in the matrix image sensor, or replaced by optical frequency doubling which is produced by an SHG crystal plate.

### TECHNICAL FIELD

The present description relates to a system and method for characterizing an electromagnetic radiation pulse by time-resolved optical gating.

### PRIOR ART

It is difficult to know the shape of an electromagnetic radiation pulse, i.e. to know its complex electromagnetic field amplitude profile, when it is a pulse of very short duration referred to as an ultrashort pulse. For example, such a pulse can last a few femtoseconds or a few tens of femtoseconds, or even slightly more than a hundred femtoseconds, and have a nominal wavelength of around 1.5 μm (micrometers). Other possible values for the nominal wavelength of ultrashort pulses to be characterized can be more generally between 1.2 μm and 2.4 μm, or between 1.7 μm and 3.4 μm, or even within other spectral ranges, including a nominal ultrashort pulse wavelength value that is close to 0.8 μm, corresponding to emissions from titanium:sapphire laser sources. Several methods have already been proposed for characterizing the complex amplitude profile of such pulses. Some of these methods, referred to as multi-shot or multiple-shot, cannot be implemented on the basis of a single pulse, because they require several pulse measurements carried out in succession. Such is the case when an optical assembly is used which causes an electromagnetic radiation pulse to interfere with itself by introducing a delay which has a unique value for each measurement. The value of the delay is then varied between successive measurements. The number of measurements which is necessary in this case can be significant, depending on the desired precision for the pulse characterization, which imposes a total characterization duration which can be long or very long. In practice, such a multi-shot method may even be unusable when the pulse repetition frequency is low. In contrast to these multi-shot characterization methods, those which are referred to as single-shot allow characterizing a pulse in a single measurement.

In addition, characterizations that involve measuring the spectrum of an electromagnetic radiation pulse are said to use frequency-resolved optical gating, designated by FROG. Such FROG characterizations can be of the multi-shot type or of the single-shot type, as described in document U.S. Pat. No. 8,068,230. They require measuring the spectrum, and because of this their hardware implementation is complicated. All FROG methods make use of a non-linear mechanism of radiation propagation, which is applied to pulse parts which are superimposed to form an interference, with a delay between these pulse parts which is denoted T. However, the non-linear mechanism that is used can vary between different FROG methods. Two-dimensional information is then collected, in the form of spectral detection signals S(ω,τ), where w is the optical pulsation which corresponds to the spectral intensity measurement performed. The complex amplitude of the pulse, denoted A(t), which characterizes its envelope shape, can then be deduced using iterative algorithms, based on all the detection signals S(ω,τ) collected when the two parameters ω and τ have values that vary independently of each other.

For FROG methods referred to as SHG-FROG, SHG standing for “Second Harmonic Generation”, the non-linear mechanism used is optical frequency doubling. This mechanism is obtained by placing a frequency-doubling crystal, also called an SHG crystal, in the path of the radiation, and by limiting detection exclusively to frequency-doubled photons. Under these conditions, each detection signal S(ω,τ) corresponds to the following formula:

S(ω,τ)=|∫A(t)·A(t−τ)·e^{iωτ}dt|²

The article entitled “Highly simplified device for ultrashort-pulse measurement” by P. O'Shea et al., Opt. Lett. 26(12), 2001, p. 932-934 describes such a single-shot SHG-FROG method.

Finally, document FR 3 034 577 describes yet another single-shot method for characterizing an electromagnetic radiation pulse. This alternative method uses a Fresnel biprism to form an interference pattern by superimposing two parts of the pulse in a portion of space, and the interference pattern is captured by an image sensor which is selected to be sensitive only to two-photon absorptions. Thus, the image sensor produces a current which is directly proportional to the probability of absorbing two photons at each location of the interference pattern. It is necessary to ensure that the image sensor does not detect photons by the usual linear absorption mechanism, by selecting it so that its spectral range of sensitivity does not contain the wavelength value(s) of the pulse. Under these conditions, the detection signals delivered by the image sensor for an ultrashort pulse, when the accumulation duration of the image sensor is greater than that of the pulse, are proportional to the square of the modulus of the autocorrelation function for the electric field, this electric field being again represented by a complex number. However, it is not possible to unequivocally deduce the complex amplitude of the pulse's electric field from the values of the square of the modulus of this autocorrelation function. Because of this, it is necessary to make the assumption of a parametric shape for the pulse in order to deduce the values of some of its parameters. These parameters can be for example the duration of the pulse, a temporal drift of its instant wavelength value, called “chirp” in the jargon of those skilled in the art, etc. But such characterization of the pulse is only partial, and can be inaccurate if the actual shape of the pulse does not match the parametric shape that was used.

### Technical Problem

Based on this situation, an object of the present invention is to propose a new method for characterizing an electromagnetic radiation pulse, which is of the single-shot type.

An additional object of the invention is to provide a complete and accurate characterization of the shape of a pulse, meaning without it being necessary to make an assumption concerning the type of parametric shape of the pulse envelope.

Yet another object of the invention is to use an optical assembly which is simple and inexpensive.

Yet another object of the invention is to make it possible to characterize pulses whose nominal wavelength lies within the range between 1.2 μm and 2.4 μm, or between 1.7 μm and 3.4 μm, or is substantially equal to 0.8 μm.

### SUMMARY OF THE INVENTION

To achieve at least one of these or other objects, a first aspect of the invention proposes a new system for characterizing an electromagnetic radiation pulse by time-resolved optical gating, which comprises:
an interference-forming device, adapted for superimposing, within an interference volume, several parts of an initial radiation which is incident on this device;
an optical input path, arranged to direct the pulse to be characterized onto the interference-forming device so that the pulse constitutes the initial radiation which is incident on this device;
a matrix image sensor, arranged to selectively capture, based on two-photon absorptions, an interference pattern formed by the pulse in the interference volume; and
a processing unit, configured to deduce shape characteristics of the pulse based on detection signals delivered by the matrix image sensor and corresponding to the interference pattern formed by the pulse.

According to the invention, the interference-forming device is adapted for superimposing four parts of the initial radiation, within the interference volume, so as to form a four-wave interference and so that the detection signals delivered by the matrix image sensor vary depending on two independent parameters associated with two different directions which are contained in the photosensitive surface of the matrix image sensor.

Within the context of the invention, two-photon absorption is understood to mean photonic transformation mechanisms that consume two photons of the pulse. Such a mechanism can occur inside the matrix image sensor, in which case the energy of the two photons which are simultaneously absorbed is transformed into an electrical detection signal. The spectral range of sensitivity of the matrix image sensor, which is defined in the usual manner for the linear absorption mechanism, i.e. with a single photon, then corresponds to the total energy of the two photons absorbed. For this reason, the spectral range of sensitivity of the matrix image sensor must include a wavelength value that is half that of each photon involved in the two-photon mechanism. Alternatively, the two photons can be absorbed simultaneously in an SHG crystal, this crystal then re-emitting a single photon which is detected by the matrix image sensor. The wavelength of the single photon which is re-emitted by the SHG crystal is equal to half that of each of the photons initially absorbed by this crystal.

In addition, the pulse characteristics which are deduced by the processing unit, based on at least part of the detection signals delivered by the matrix image sensor, comprise instant values of the modulus and phase of the complex field amplitude of the pulse.

Consequently, the pulse characterization that is provided by the system of the invention is of the single-shot type, due to the sampling of the interference pattern produced by the matrix image sensor. In addition, it is of the time-resolved optical gating type, since each location in the interference pattern corresponds to values of two delays which are applied between several parts of the pulse by the interference-forming device.

Thanks to the fact that the interference pattern is two-dimensional, with variations in intensity which are independent between both directions of the matrix image sensor, much more complete information is collected about the pulse by the system of the invention. It is then possible to deduce a complete characterization of the shape of the pulse, by the instant values of the modulus and phase of the complex amplitude of the pulse field, for example its electric field. This way, no assumption about a type of parametric shape for the pulse envelope is necessary, so that the characterization of the pulse shape that is provided by the system of the invention is accurate.

The four-wave interference-forming device used in the system of the invention can be particularly simple. In particular, its implementation can be much simpler than that of a spectrometer. For example, it may be a portion of a refractive material bounded by an optical input face which is flat and by four optical output faces which are also flat, the four output faces being images of each other through 90°-rotations around an optical axis which is perpendicular to the input face. For such an embodiment of the interference-forming device, each output face forms with the input face a prism which has a non-zero vertex angle, and in addition it is oriented so that a beam part of the initial radiation which is incident on the input face parallel to the optical axis and which exits through this output face is deflected by the portion of refracting material towards the optical axis downstream of the interference-forming device.

Alternatively, the interference-forming device used in the system of the invention may comprise two biprisms each made of refractive material and which are arranged one after the other on a propagation path of the initial radiation, with respective edges of these two biprisms having different orientations when projected on a plane perpendicular to the propagation path of the initial radiation. Preferably, the edges of the two biprisms may be orthogonal when projected on the plane perpendicular to the propagation path of the initial radiation.

In first embodiments of the invention, the processing unit may be configured for:
selecting at least one component of a decomposition by two-dimensional Fourier transformation of the interference pattern as captured by the matrix image sensor selectively from the two-photon absorptions, and
deducing the instant values of the modulus and phase of the complex field amplitude of the pulse, based on the at least one selected component.

Advantageously, the processing unit may be configured so that the component selected in the decomposition by two-dimensional Fourier transformation of the interference pattern has zero values outside the interference volume. The result of the pulse characterization which is provided by the system of the invention thus depends to a lesser extent, or does not depend at all, on the size of the spatial detection window comprised of the photosensitive surface of the matrix image sensor.

For example, the component of the decomposition by two-dimensional Fourier transformation of the interference pattern, which is selected by the processing unit, may be associated with two times a nominal frequency of the pulse to be characterized along one of the directions of the matrix image sensor, and associated with only one time this nominal frequency of the pulse to be characterized along the other direction of the matrix image sensor, when the detection signals delivered by the matrix image sensor are expressed as functions of delay contributions generated by respective displacements along the two directions of the matrix image sensor. This component is called F_{2,1}, and the instant values of the modulus and phase of the complex field amplitude of the pulse are deduced from this component F_{2,1} by the processing unit. Component F_{2,1} has zero values outside the interference volume.

Alternatively, the processing unit may be configured to select the component of the decomposition by two-dimensional Fourier transformation of the interference pattern, referred to as F_{2,0}, which is associated with two times the nominal frequency of the pulse to be characterized along a first of the directions of the matrix image sensor, but without being associated with any variation along a second direction of the matrix image sensor, when the detection signals delivered by the matrix image sensor are expressed as functions of delay contributions generated by respective displacements along the two directions of the matrix image sensor. The instant values of the modulus and phase of the complex field amplitude of the pulse are then deduced from this component F_{2,0} by the processing unit. However, the values of component F_{2,0} are not zero outside the interference volume. To overcome this drawback, the processing unit may be configured to also select the component of the decomposition by two-dimensional Fourier transformation of the interference pattern, referred to as F_{2,2}, which is associated with two times the nominal frequency of the pulse to be characterized along the first of the directions of the matrix image sensor, and which is also associated with two times the nominal frequency of the pulse to be characterized along the second direction of the matrix image sensor, again when the detection signals delivered by the matrix image sensor are expressed as functions of the delay contributions generated by respective displacements along the two directions of the matrix image sensor. Then, the processing unit is also configured for calculating respective one-dimensional Fourier transforms of components F_{2,0} and F_{2,2} with respect to the delay contributions generated by the displacements along the first of the directions of the matrix image sensor, these one-dimensional Fourier transforms being denoted TF₁(F_{2,0}) for component F_{2,0}, and TF₁(F_{2,2}) for component F_{2,2}. It is then configured for deducing the instant values of the modulus and phase of the complex field amplitude of the pulse, based on a result of TF₁(F_{2,0})−2·Mod[TF₁(F_{2,2})], where Mod[.] denotes a complex number modulus.

In second embodiments of the invention, the system for characterizing an electromagnetic pulse by time-resolved optical gating may further comprise:
a plate of a frequency-doubling crystal, referred to as a SHG crystal plate, which is placed in the interference volume;
relay optics, which form an image of the SHG crystal plate on the matrix image sensor; and
a diaphragm, which is arranged on an optical path between the SHG crystal plate and the matrix image sensor, for selectively transmitting towards the matrix image sensor a beam of radiation which propagates parallel to a direction of propagation of the pulse that is effective upstream of the interference-forming device relative to the direction of propagation of this pulse.
   For such second embodiments of the invention, the matrix image sensor is implemented or selected to detect only photons of doubled optical frequency which are produced by the SHG crystal plate, excluding photons of the pulse which have passed through this SHG crystal plate. Optionally, the spectral detection range of the matrix image sensor which is used with such an SHG crystal plate may be limited by a spectral filter which is located on the optical path between this plate and this sensor, so as to suppress detection of the photons of the pulse which have passed through the SHG crystal plate.

Such second embodiments are particularly suitable for characterizing pulses which have nominal wavelength values close to 0.8 μm. Indeed, for such nominal wavelength values, there is currently no matrix image sensor that is able to operate solely via the two-photon absorption mechanism.

A second aspect of the invention provides a method for characterizing an electromagnetic radiation pulse by time-resolved optical gating, which is executed using a system according to the first aspect above. In addition, the pulse to be characterized has a spectrum such that all the wavelength values which correspond to non-zero or substantially non-zero spectral amplitudes are outside a spectral detection range of the matrix image sensor, and such that results of dividing by two these wavelength values of the pulse spectrum which correspond to non-zero or substantially non-zero spectral amplitudes, are inside the spectral detection range of the matrix image sensor.

The spectral detection range of the matrix image sensor may be directly its spectral sensitivity range. In this case, the spectral sensitivity range of the matrix image sensor must exclude all wavelength values of the pulse spectrum which correspond to non-zero or substantially non-zero spectral amplitudes, and must contain the results of dividing by two these wavelength values of the pulse spectrum which correspond to non-zero or substantially non-zero spectral amplitudes. For example, the matrix image sensor which is used in the system of the invention may be of a silicon-based type, in which case its spectral range of sensitivity extends from approximately 400 nm (nanometers) to 1200 nm, in wavelength values. Then, all wavelength values of the spectrum of the pulse to be characterized which correspond to non-zero or substantially non-zero spectral amplitudes must be between 1200 nm and 2400 nm. Alternatively, the matrix image sensor may be of a type based on an indium-gallium-arsenic (InGaAs) alloy, and in this case all the wavelength values of the spectrum of the pulse to be characterized which correspond to non-zero spectral amplitudes must be between 1700 nm and 3400 nm. For the second embodiments described above, which use an SHG crystal plate, and when a spectral filter is used simultaneously, the spectral detection range results from the combination of the spectral sensitivity range of the matrix image sensor and a spectral transmission window of the filter.

### BRIEF DESCRIPTION OF FIGURES

The features and advantages of the invention will become more clearly apparent in the following detailed description of some non-limiting embodiments, with reference to the appended figures, which include:

FIG. 1a is a perspective view of an interference-forming device which may be used in a system according to the invention;

FIG. 1b gathers a plan view and section views of the interference-forming device of FIG. 1a;

FIG. 1c corresponds to FIG. 1a for an alternative embodiment of the invention;

FIG. 2 is a block diagram of a first embodiment of a system according to the invention;

FIG. 3 shows steps executed by a processing unit of a system according to FIG. 2;

FIG. 4 is a diagram that illustrates a characterization result of an electromagnetic radiation pulse, as provided by the system of FIG. 2; and

FIG. 5 corresponds to FIG. 2 for a second embodiment of a system according to the invention.

### DETAILED DESCRIPTION OF THE INVENTION

For clarity sake, the dimensions of the elements that are represented in these FIGS. correspond neither to actual dimensions nor to actual dimension ratios. Furthermore, some of these elements are represented only symbolically, and identical references indicated in different figures designate elements which are identical or which have identical functions.

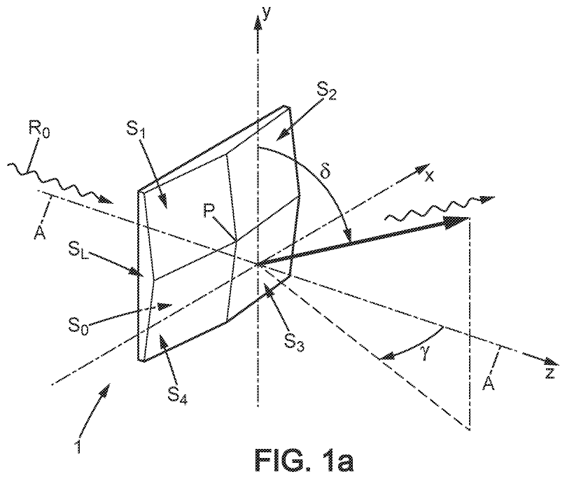

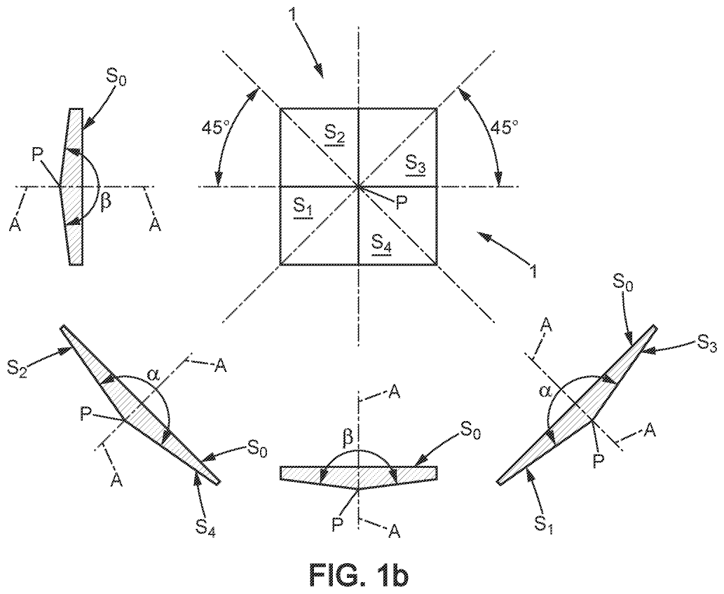

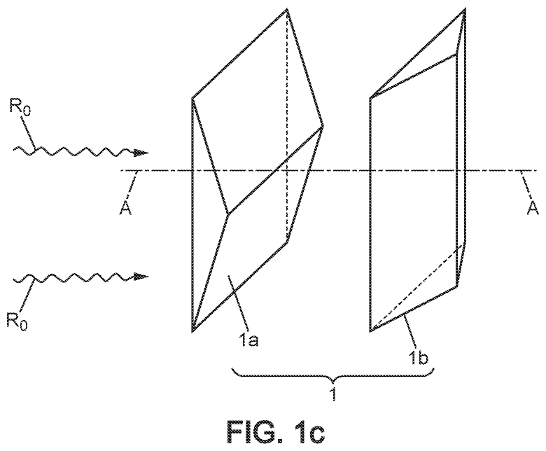

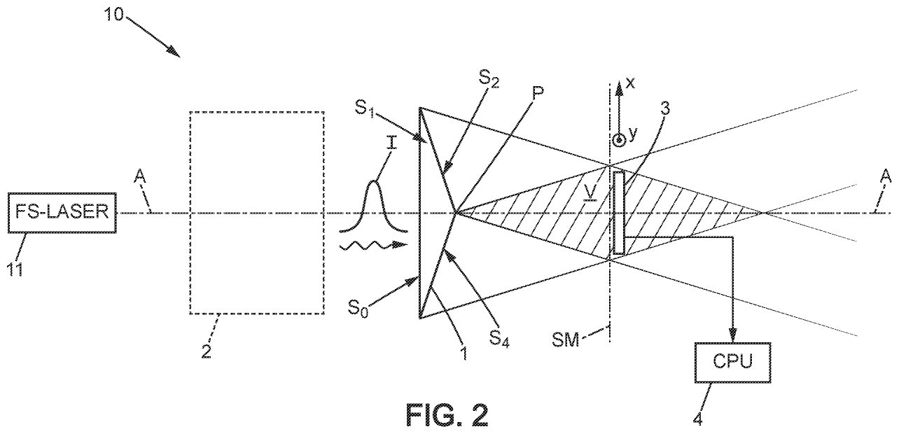

As represented in FIG. 1a and FIG. 1b, an interference-forming device 1 comprises a portion of a homogeneous material, transparent and refractive for the nominal wavelength of an electromagnetic radiation pulse to be characterized. S₀ designates an optical input face of this portion, which is flat, and S₁, S₂, S₃ and S₄ designate its four optical output faces which have identical shapes and are each also flat. The four output faces S₁-S₄ are located on a side of the portion of refractive material which is opposite to that of the input face S₀. Furthermore, the output faces S₁-S₄ are distributed around an optical axis A-A which is perpendicular to the input face S₀, according to an order-four rotational symmetry so that an initial beam of radiation R₀ which is incident on the input face S₀ while being parallel to this optical axis and centered relative to it, exits in an evenly distributed manner through the four output faces S₁-S₄. In addition, each output face S₁-S₄ is angled relative to the input face S₀ so that the device 1 divides the initial beam of radiation R₀ into four beam parts which exit the portion of refracting material, one via each of the output faces S₁-S₄, in respective propagation directions which approach the optical axis A-A. The parts of the beam which exit the output faces S₁-S₄ are thus superimposed inside an interference volume which is denoted V (see FIG. 2), and which extends from a vertex P that is common to the four output faces. A side surface S_{L} of the portion of refracting material which constitutes the interference-forming device 1, between the input face S₀ on the one hand and the output faces S₁-S₄ on the other hand, may have a shape chosen to increase a cross-sectional area of the interference volume V. The angle between the respective bisectors originating from the vertex P of two of the output faces S₁-S₄ which are opposite each other relative to the optical axis A-A is denoted α, and may be about 160° (degrees). Two output faces which are adjacent are separated by a rectilinear edge, and two of these edges which are opposite each other relative to the optical axis A-A form between them an angle β. The respective values of angles α and β are related by the formula:

$$α = acos ( - \frac{1 - 2 \cdot {tan}^{2} ( β )}{1 + 2 \cdot {tan}^{2} ( β )} ) ,$$

where a cos(.) denotes the reciprocal function of cosine, and tan(.) denotes the tangent function.

The angles □ and □ of emergence of the radiation which are produced by the interference-forming device 1 when the initial radiation R₀ is incident on the input face S₀ parallel to the optical axis A-A, as these angles □ and □ are shown in FIG. 1a, are given by the formulas: δ=a sin(2^{-1/2}·sin(θᵣ)) and γ=a tan(2^{-1/2}·tan(θᵣ)), where sin(.) and a sin(.) denote the sine and its reciprocal function, a tan(.) denotes the tangent reciprocal function, and θᵣ is given by

$${θ}_{r} = asin ( \frac{n \sqrt{2} \cdot tan ( β )}{\sqrt{1 + 2 \cdot {tan}^{2} ( β )}} ) - asin ( \frac{\sqrt{2} \cdot tan ( β )}{\sqrt{1 + 2 \cdot {tan}^{2} ( β )}} ) ,$$

n being the refractive index of the material which constitutes the interference-forming device 1 for the nominal wavelength of the initial radiation R₀.

In FIG. 2, the reference 10 denotes in general a system for characterizing an electromagnetic radiation pulse by time-resolved optical gating which is in accordance with the invention. The system 10 comprises the interference-forming device 1, an input optical path 2, a matrix image sensor 3, and a processing unit 4. The plane of FIG. 2 contains the bisectors of two of the output faces of device 1 which are opposite each other relative to the optical axis A-A, for example the respective bisectors of output faces S₂ and S₄. The reference I designates the pulse to be characterized. It may be produced by a source 11 of ultrashort laser pulses, also called a femtosecond laser and denoted FS-LASER, for example with a nominal wavelength λ₀ which is close to the value 1550 nm.

The input optical path 2 may be designed to adapt a beam cross-section size of the pulse I according to the size of the input face S₀ of the interference-forming device 1. It can comprise input optics, for example based on a combination of several spherical mirrors and/or lenses. The input optical path 2 is preferably designed so that the pulse I is incident on the input face S₀ such that it is parallel to axis A-A, and in a manner that is centered on this axis. Thus, the pulse I constitutes the initial radiation R₀ for the interference-forming device 1. Under these conditions, the interference volume V begins at the common vertex P of the output faces S₁-S₄, is symmetrical with respect to axis A-A, and has a cross-section perpendicular to axis A-A which increases up to a plane of maximum cross-section area, denoted SM.

The matrix image sensor 3 has for example 600×600 photosensitive elements. It is placed in the interference volume V, perpendicular to axis A-A, preferably close to the plane of maximum cross-section SM. It is oriented so that its directions of rows and columns of photosensitive elements, denoted x and y respectively, are parallel one-to-one to the lateral sides of the interference volume V. The angle α of the interference-forming device 1 is salient, being sufficiently close to 180° for the interference fringes produced in the volume V to be resolved by the matrix image sensor 3. Thus, the pitch p of the photosensitive elements of this matrix image sensor determines a lower limit for the angle α. To meet the Nyquist condition, the angle θᵣ introduced above must satisfy the inequality:

$$sin ( {θ}_{r} ) < \frac{{λ}_{0}}{4 \sqrt{2} \cdot p} ,$$

where λ₀ is again the nominal wavelength of the pulse I. For example, the pitch p of the photosensitive elements may be equal to 1.6 μm when the nominal wavelength λ₀ is equal to about 1550 nm.

The matrix image sensor 3 is selected or implemented so that it is not sensitive to the nominal wavelength value λ₀ of the pulse I, but is sensitive within a spectral range which contains the half-value of this nominal wavelength value λ₀, i.e. λ₀/2, by extending sufficiently to either side of λ₀/2. When the nominal wavelength λ₀ of the source 11 of the laser pulses is around 1550 nm, the matrix image sensor 3 can be silicon-based. Under these conditions, the matrix image sensor 3 is sensitive to two-photon absorptions generated by the pulse I and occurring in its photosensitive elements, and for which the number of occurrences depends on where each photosensitive element is located inside the interference volume V. Since the pulse I is much shorter than the accumulation time of the photosensitive elements of the matrix image sensor 3, the detection signal delivered by each photosensitive element of the matrix image sensor 3 is:

S(τ₁,τ₂)=∫_{-∞}^{+∞}|Eₜₒₜ(t,τ₁,τ₂)|⁴dt

where Eₜₒₜ is the electric field generated by the pulse I at a point in the interference volume V and at time t. By taking one of the four waves produced by the interference-forming device 1 at the location of the photosensitive element considered as a phase shift reference, the electric field Eₜₒₜ is given by:

Eₜₒₜ(t,τ₁,τ₂)=A(t)·e^{-iω}^{₀}^{t}+A(t−τ₁)·e^{-iω}^{₀}^{(t-τ}^{₁}⁾+A(t−τ₂)·e^{-iω}^{₀}^{(t-τ}^{₂}⁾+A(−τ₁−τ₂)·e^{-iω}^{₀}^{(t-96}^{₁}^{-τ}^{₂}⁾+complex conjugate

where τ₁ and τ₂ are the delays resulting from displacements along the two directions x and y relative to the wave used as the phase shift reference. ω₀ is the nominal pulsation of the pulse I, equal to 2π·C/λ₀ where C is the speed of propagation of the radiation in air. A(t) is the complex amplitude of the electric field of pulse I at time t, so the instant electric field of the pulse I is:

A(t)·e^{-iω}^{₀}^{t}

When the interference-forming device 1 has the composition of FIG. 1a and FIG. 1b, the delays τ₁ and τ₂ have the following expressions as functions of the displacements along the two directions x and y:

$${τ}_{1} = \frac{\sqrt{2} sin ( {θ}_{R} ) \cdot x}{C} and {τ}_{2} = \frac{\sqrt{2} sin ( {θ}_{R} ) \cdot y}{C}$$

The detection signals S(τ₁,τ₂) which are then delivered by the photosensitive elements of the matrix image sensor 3 comprise twenty-five terms which can each be identified by two relative integer values n and m, n being equal to −2, −1, 0, +1, or +2 and m being independently also equal to −2, −1, 0, +1, or +2. The term of the pair (n, m) is proportional to exp[−i(n·ω₀·τ₁+m·ω₀·τ₂)], where exp[.] designates the exponential function.

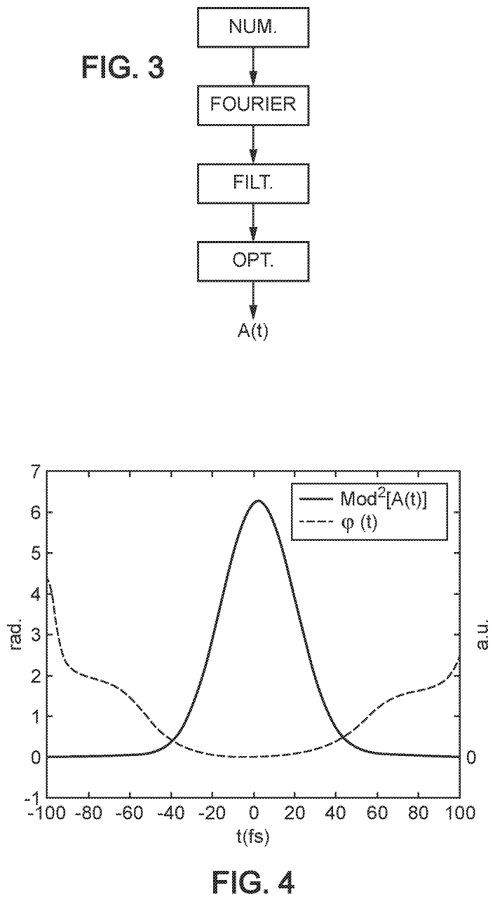

The processing unit 4 is denoted CPU in FIG. 2. It is connected so that it receives as input the detection signals S(τ₁,τ₂) delivered by the photosensitive elements of the matrix image sensor 3, and outputs a characterization of the shape of the pulse I, in the form of complex values of A(t). The steps executed by the processing unit 4 are now described with reference to FIG. 3.

The processing unit 4 digitizes the detection signals S(τ₁,τ₂) in the step denoted DIGITZ. It then calculates a two-dimensional Fourier transform with respect to the two variables τ₁ and τ₂, in the next step denoted FOURIER. A two-variable function TF(S)(ω₁,ω₂) is thus obtained, where ω₁ is the variable conjugate to τ₁, ω₂ is the variable conjugate to τ₂, and TF(S) denotes the two-dimensional Fourier transform of the signals S(τ₁,τ₂). The function TF(S)(ω₁,ω₂) is composed of twenty-five peaks which correspond to the twenty-five terms indicated above for the function S(τ₁,τ₂). An adaptive filtering is then applied to one of these peaks, in the step denoted FILT., to isolate at least one of the components, corresponding to a value of n and to a value of m. For example, filtering isolates the peak corresponding to ω₁=2·ω₀ and ω₂=ω₀, i.e. n=2 and m=1, with a certain width of the two-dimensional filtering window around this peak. This filtering window width in the plane of the pulsation values ω₁,ω₂ is adapted to remain sufficiently far from the other peaks. A filtered function derived from TF(S)(ω₁,ω₂) is then constructed, keeping the values of TF(S)(ω₁,ω₂) in the filtering window without modifying them, and supplementing with zero values outside the filtering window. Finally, an inverse two-dimensional Fourier transformation is applied to the filtered function TF(S)(ω₁,ω₂). The component of the function S(τ₁,τ₂) which corresponds to n=2 and m=1 has thus been isolated. It is denoted F_{2,1} and is again a function of the two delays τ₁ and τ₂. The filtering method just described is commonly called adaptive filtering by those skilled in the art. It provides a sampling of the values of the function F_{2,1}(τ₁,τ₂).

Moreover, by carrying over the expression from Eₜₒₜ (t,τ₁,τ₂) into S(τ₁,τ₂) and by expanding the necessary terms, we obtain:

F_{2,1}(τ₁,τ₂)=2[∫A²(t)A*(t−τ₁−τ²)A*(t−τ₁)dt+∫A(t)A*²(t−τ₁τ₂)A(t−τ₂)dt]e^{-i(2·ω}^{₀}^{·τ}^{₁}^{+ω}^{₀}^{·τ}^{₂}⁾

By using an optimization algorithm known to those skilled in the art, it is then possible to deduce the function A(t) from the values of F_{2,1}(τ₁,τ₂) as supplied by the step of filtering the detection signals. Obtaining the function A(t) in this way is possible thanks to the fact that the starting data F_{2,1} is a function of two independent variables, namely τ₁ and τ₂. This step is denoted OPT. in FIG. 3. For example, optimization algorithms possible to use are those referred to as reconstruction algorithms, such as generalized projection algorithms.

For the OPT. step, the inventors used an algorithm which is commonly called a genetic algorithm. Such a genetic algorithm makes use of mechanisms inspired by natural selection to optimize a set of values in order to reproduce a target. For the invention, the purpose of the algorithm is to determine the instantaneous amplitude values A(t), expressed in modulus denoted Mod[A(t)] and in phase denoted φ(t), which allow best reproducing the values of F_{2,1}(τ₁,τ₂), provided by step FILT., which constitute the target. Equivalently, the algorithm can determine the amplitude AO)) of the spectral components of the function A(t), by their modulus Mod[A(ω)] and their phase φ(ω). Similarly, it is also equivalent to use as the optimization target the values of the filtered TF(S)(ω₁,ω₂) that were obtained during the FILT step. Starting values are adopted for Mod[A(ω)] and φ(ω), for a set of sample values of pulsation ω. These starting values determine a starting shape for the pulse I, from which an estimate of TF(F_{2,1})(ω₁,ω₂) is calculated, where TF(F_{2,1})(ω₁,ω₂) is the two-dimensional Fourier transform of F_{2,1}(τ₁,τ₂) deduced from the expression given above for this latter. For the genetic algorithm, each pair of starting values adopted for Mod[A(ω)] and φ(ω), for a same values of to, constitutes a gene, and the set of values for Mod[A(ω)] and φ(ω) which are associated with all the sampling values of ω constitute an individual. The genetic algorithm starts with a set of individuals who are randomly selected and who constitute an initial population. The function TF(F_{2,1})(ω₁,ω₂) is calculated for each individual of the initial population, and the result obtained for each individual is compared with the filtered TF(S)(ω₁,ω₂) as obtained from the FILT step, based on the detection signals S(τ₁,τ₂). A score is then assigned to each individual, which quantifies the level of coincidence between its evaluation for the function TF(F_{2,1})(ω₁,ω₂) and the values of the filtered TF(S)(ω₁,ω₂). This coincidence is sought between the two functions TF(F_{2,1}) and filtered TF(S) when the two variables ω₁ and ω₂ vary independently of each other. The individuals with the lowest scores are eliminated, and those with the highest scores are selected to become parents of a new generation of individuals. The genes of each individual of the new generation are obtained by mixing those of two selected parents, and by introducing random mutations of one or more of the genes. Comparison of the individuals to the values of the filtered TF(S)(ω₁,ω₂) deduced from the detection signals is then repeated with the individuals of the new generation, and the whole process is repeated for each successive generation. These repetitions are chained in this manner until convergence is obtained, i.e. a situation is obtained where individuals from one generation to the next no longer or barely improve the coincidence scores. The individual with the best score constitutes the result for the shape of the pulse I.

The diagram of FIG. 4 shows the result thus obtained from component F_{2,1}. The horizontal axis of the diagram identifies the time, denoted t and expressed in femtoseconds (fs). The vertical axis at the left of the diagram identifies the values of φ(t), expressed in radians, and the vertical axis at the right of the diagram identifies the values of Mod²[A(t)] expressed in arbitrary units (a.u.). The pulse I that has been characterized therefore has a duration of about 40 fs.

Alternatively, the shape of the pulse I may be obtained according to the invention by using component F_{2,0} of the decomposition by two-dimensional Fourier transformation of function S(τ₁,τ₂), corresponding to n=2 and m=0, instead of component F_{2,1}. This component F_{2,0} is the following, according to the expressions of E_{TOT}(t,τ₁,τ₂) and S(τ₁,τ₂):

F_{2,0}(τ₁,τ₂)=[2·∫A²(t)A*²(t−τ₁)dt+4·∫A(t)A*(t−τ₁)A(t−τ₂)A*(t−τ₁−τ₂)dt]e^{-i(2·ω}^{₀}^{·τ}^{₁}⁾

However, unlike component F_{2,1}, component F_{2,0} is not zero outside the interference volume V. In order to recover such cancellation for values that come from the detection signals and are used in step OPT., it is possible to use the results of TF₁(F_{2,0})(ω₁,τ₂)−2·Mod[TF₁(F_{2,2})(ω₁,τ₂)], where F_{2,2} denotes the component of the decomposition by two-dimensional Fourier transformation of function S(τ₁,τ₂) which corresponds to n=2 and m=2, and TF₁(.) denotes the one-dimensional Fourier transformation which is performed with respect to the delay variable τ₁. The expression for component F_{2,2} is:

F_{2,2}(τ₁,τ₂)=∫A²(t)A*²(t−τ₁−τ₂)dt·e^{-i(2·ω}^{₀}^{·τ}^{₁}^{+2·ω}^{₀}^{·τ}^{₂}⁾

and thus:

TF₁(F_{2,0})(ω₁,τ₂)−2·Mod[TF₁(F_{2,2})(ω₁,τ₂)]=Mod²[∫A(t)A(t−τ₂)e^{i(ω}^{₁}^{-2·ω}^{₀}^{)t}dt]

The function TF₁(F_{2,0})(ω₁,τ₂)−2·Mod[TF₁(F_{2,2})(ω₁,τ₂)] which is thus obtained is identical to that mentioned for the SHG-FROG methods described in the article entitled “Measuring ultrashort laser pulses in the time-frequency domain using frequency-resolved optical gating”, by R. Trebino et al., Rev. Science. Instrum. 68 (9), September 1997, American Institute of Physics, pp. 3277-3295.

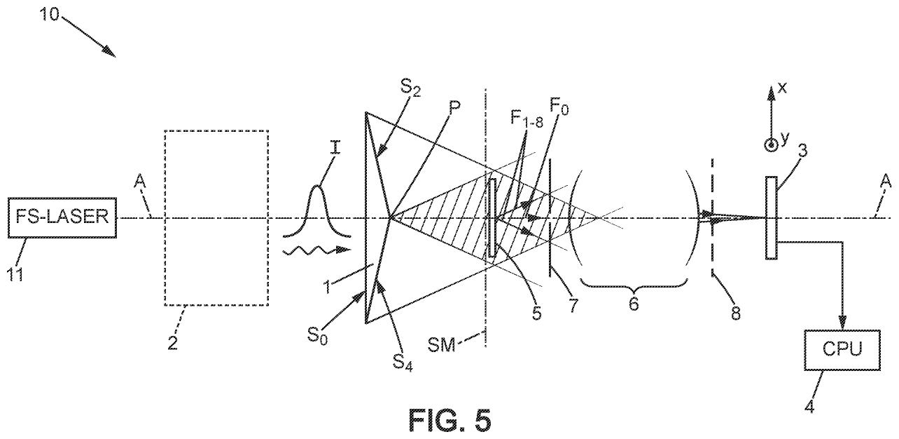

FIG. 5 illustrates another embodiment of the invention, for which the two-photon mechanism is implemented independently of the matrix image sensor, i.e. implemented outside this sensor. To do so, the matrix image sensor is replaced inside the interference volume V by an SHG crystal plate which is designated by the reference 5. Relay optics 6 are used to image this SHG crystal plate 5 on the matrix image sensor 3. This can be a single convergent lens, but any other optical imaging device can also be used. The magnification value of the relay optics 6 is known, or can be determined by a calibration procedure which is common in the technical field of imaging. As before, the interference-forming device 1 divides the radiation of the pulse I into four oblique beams which converge towards the optical axis A-A, with respective directions of propagation which are transformed by successive rotations of 90° (degree) into each other around the optical axis A-A. Under these conditions, the SHG crystal plate 5 transforms these four beams, which have the wavelength value of the pulse I as their wavelength value, into nine beams which have wavelength values substantially equal to half that of pulse I. One of these nine beams, denoted F₀ in FIG. 5, propagates parallel to the optical axis A-A. The other eight beams, denoted in general as F₁₋₈ in the figure, propagate obliquely to the optical axis A-A, having respective wave vectors that point to the vertices and midpoints of the sides of a square in the three-dimensional k-space, and being spatially distributed around beam F₀. A diaphragm 7 is placed between the SHG crystal plate 5 and the matrix image sensor 3, for example just before the relay optics 6, to allow only beam F₀ to travel through in the direction of the matrix image sensor 3, blocking the oblique beams F₁₋₈. Depending on the nominal wavelength value of the pulse I in comparison to the spectral sensitivity range of the matrix image sensor 3, it may be necessary to add a spectral filter 8 between the SHG crystal plate 5 and the matrix image sensor 3. For example, the filter 8 may be placed between the relay optics 6 and the sensor 3. In this case, the filter 8 is selected to allow the passage of radiation having a wavelength value substantially equal to half the nominal wavelength of the pulse I, being opaque to this nominal wavelength value of the pulse I. However, if the spectral sensitivity range of the image sensor matrix 3 excludes the nominal wavelength value of the pulse I while including its half-value, the filter 8 is not necessary. Under these conditions, and using the notations already used, the detection signal which is delivered by each photosensitive element of the matrix image sensor 3 is:

S(τ₁,τ₂)=∫_{-∞}^{+∞}|A(t)·A(t−(τ₁+τ₂))+A(t−τ₁)·A(t−τ₂)|²dt

In the absence of the diaphragm 7, function S(τ₁,τ₂) would have the same twenty-five terms as in the embodiment of the invention represented in FIG. 2, and it is optical filtering which is produced by the diaphragm 7, in the form of an adaptive spatial filtering, which reduces this function S(τ₁,τ₂) to the single term ∫|A(t)·A(t−(τ₁+τ₂))+A(t−τ₁)·A(t−τ₂)|²dt. It is then no longer necessary, for the embodiment of FIG. 5, that the processing unit 4 carries out a digital adaptive filtering of Fourier components of the image captured by the matrix image sensor 3. The complex field amplitude A(t) or A(ω) can then be deduced by the processing unit 4 directly from the signals S(τ₁,τ₂) by using a reconstruction algorithm as described above, in particular the genetic algorithm.

It is understood that the invention may be reproduced by modifying secondary aspects of the embodiments which have been described in detail above, while retaining at least some of the cited advantages. In particular, we list the following modifications in a non-exhaustive manner
the interference-forming device 1 can be different from that of FIG. 1a and FIG. 1b. For example, FIG. 1c shows another four-wave interference-forming device, which comprises two biprisms arranged one behind the other on the propagation path of the initial radiation R₀, this latter to be composed of the pulse I to be characterized. The references 1a and 1b which are indicated in FIG. 1c respectively denote these two biprisms. The respective edges of the two biprisms 1a and 1b are preferably mutually perpendicular when projected on a plane which is perpendicular to axis A-A;
For the embodiment of FIG. 2 and FIG. 3, a filtered component of the interference pattern, other than F_{2,1} and F_{2,0}, or a combination of several filtered components of the interference pattern, other than TF₁(F_{2,0})−2·Mod[TF₁(F_{2,2})], may be used to deduce the shape of the pulse I to be characterized. In particular, components F_{1,2} and F_{0,2} can be used instead of F_{2,1} and F_{2,0} by swapping the roles of □₁ and □₂ in the equations and by calculating a one-dimensional Fourier transformation not on the first variable but on the second one;
a reconstruction algorithm which is different from the described genetic type may be used; and
all the numerical values that have been cited have been provided for illustration purposes only, and can be changed according to the application of concern.

1-12. (canceled)

13. A system for characterizing an electromagnetic radiation pulse by time-resolved optical gating, comprising:
an interference-forming device, adapted for superimposing, within an interference volume, several parts of an initial radiation which is incident on said device;
an input optical path, arranged to direct the pulse to be characterized onto the interference-forming device so that the pulse constitutes the initial radiation which is incident on said device;
a matrix image sensor, arranged to selectively capture, based on two-photon absorptions, an interference pattern formed by the pulse in the interference volume; and
a processing unit, configured to deduce shape characteristics of the pulse based on detection signals delivered by the matrix image sensor and corresponding to the interference pattern formed by the pulse,
wherein the interference-forming device is adapted for superimposing four parts of the initial radiation, within the interference volume, so as to form a four-wave interference and so that the detection signals delivered by the matrix image sensor vary depending on two independent parameters associated with two different directions which are contained in a photosensitive surface of said matrix image sensor,
and wherein the characteristics of the pulse which are deduced by the processing unit, based on at least part of the detection signals delivered by the matrix image sensor, comprise instant values of a modulus and a phase of a complex field amplitude of the pulse.

14. The system according to claim 13, wherein the interference-forming device comprises a portion of a refractive material bounded by an optical input face which is flat and by four optical output faces which are also flat, the four output faces being images of each other through 90°-rotations around an optical axis which is perpendicular to the input face, and each output face forming with the input face a prism which has a non-zero vertex angle, and being oriented so that a beam part of the initial radiation which is incident on the input face parallel to the optical axis and which exits through said output face is deflected by the portion of refractive material towards said optical axis downstream of the interference-forming device,
or the interference-forming device comprises two biprisms each made of refractive material and which are arranged one after the other on a propagation path of the initial radiation, with respective edges of the two biprisms having different orientations when projected on a plane perpendicular to said propagation path of the initial radiation.

15. The system according to claim 13, wherein the processing unit is configured for:
selecting at least one component of a decomposition by two-dimensional Fourier transformation of the interference pattern as captured by the matrix image sensor selectively from the two-photon absorptions, and
deducing the instant values of the modulus and phase of the complex field amplitude of the pulse, based on the at least one selected component.

16. The system according to claim 15, wherein the selected component has zero values outside the interference volume.

17. The system according to claim 16, wherein the selected component, referred to as F_{2,1}, is associated with two times a nominal frequency of the pulse to be characterized along one of the directions of the matrix image sensor, and is associated with only one time said nominal frequency of the pulse to be characterized along another of said directions of the matrix image sensor, when the detection signals delivered by the matrix image sensor are expressed as functions of delay contributions generated by respective displacements along the two directions of the matrix image sensor,
and the instantaneous values of the module and phase of the complex field amplitude of the pulse are deduced from component F_{2,1} by the processing unit.

18. The system according to claim 15, wherein the selected component, referred to as F_{2,0}, is associated with two times a nominal frequency of the pulse to be characterized along one of the directions of the matrix image sensor, but without being associated with any variation along another of said directions of said matrix image sensor, when the detection signals delivered by the matrix image sensor are expressed as functions of delay contributions generated by respective displacements along the two directions of the matrix image sensor,
and the instant values of the modulus and phase of the complex field amplitude of the pulse are deduced from component F_{2,0} by the processing unit.

19. The system according to claim 15, wherein the processing unit is configured for selecting the component of the decomposition by two-dimensional Fourier transformation of the interference pattern, referred to as F_{2,0}, which is associated with two times a nominal frequency of the pulse to be characterized along a first of the directions of the matrix image sensor, but without being associated with any variation along a second of said directions of the matrix image sensor, when the detection signals delivered by the matrix image sensor are expressed as functions of delay contributions generated by respective displacements along the two directions of the matrix image sensor,
and furthermore for selecting the component of the decomposition by two-dimensional Fourier transformation of the interference pattern, referred to as F_{2,2}, which is associated with two times the nominal frequency of the pulse to be characterized along the first of the directions of the matrix image sensor, and which is also associated with two times the nominal frequency of the pulse to be characterized along the second of said directions of the matrix image sensor, again when the detection signals delivered are expressed as functions of the delay contributions generated by respective displacements along the two directions of the matrix image sensor,
and the processing unit is further configured for calculating respective one-dimensional Fourier transforms of components F_{2,0} and F_{2,2} with respect to the delay contributions generated by the displacements along the first of the directions of the matrix image sensor, said one-dimensional Fourier transforms being denoted TF₁(F_{2,0}) for component F_{2,0}, and TF₁(F_{2,2}) for component F_{2,2},
and for deducing the instant values of the modulus and phase of the complex field amplitude of the pulse, based on a result of TF₁(F_{2,0})−2·Mod[TF₁(F_{2,2})], where Mod[.] denotes a complex number modulus.

20. The system according to claim 13, further comprising:
a plate of a frequency-doubling crystal, which is placed in the interference volume;
relay optics, which form an image of the frequency-doubling crystal plate on the matrix image sensor; and
a diaphragm, which is arranged on an optical path between the frequency-doubling crystal plate and the matrix image sensor, for selectively transmitting towards said matrix image sensor a beam of radiation which propagates parallel to a direction of propagation of the pulse that is effective upstream of the interference-forming device relative to a direction of propagation of said pulse,
and wherein the matrix image sensor is implemented or selected to detect only photons of doubled optical frequency which are produced by the frequency-doubling crystal plate, excluding photons of the pulse which have passed through said frequency-doubling crystal plate.

21. The system according to claim 20, further comprising:
a spectral filter which is located on the optical path between the frequency-doubling crystal plate and the matrix image sensor, to limit a spectral detection range of said matrix image sensor in order to suppress detection of the photons of the pulse which have passed through said frequency-doubling crystal plate.

22. A method for characterizing an electromagnetic radiation pulse by time-resolved optical gating, executed using a system according to claim 13,
and wherein the pulse to be characterized has a spectrum such that all the wavelength values which correspond to non-zero spectral amplitudes are outside a spectral detection range of the matrix image sensor, and such that results of dividing by two said wavelength values of the pulse spectrum which correspond to non-zero spectral amplitudes, are inside said spectral detection range of the matrix image sensor.

23. The method according to claim 22, wherein the spectral detection range of the matrix image sensor is a spectral sensitivity range of said matrix image sensor, said spectral sensitivity range excluding all wavelength values of the spectrum of the pulse which correspond to non-zero spectral amplitudes, and containing the results of dividing by two said wavelength values of the pulse spectrum which correspond to non-zero spectral amplitudes.

24. The method according to claim 23, wherein the matrix image sensor is of a silicon-based type, and all wavelength values of the spectrum of the pulse to be characterized which correspond to non-zero spectral amplitudes, are between 1200 nm and 2400 nm,
or wherein the matrix image sensor is of a type based on an indium-gallium-arsenic alloy, and all the wavelength values of the spectrum of the pulse to be characterized which correspond to non-zero spectral amplitudes, are between 1700 nm and 3400 nm.
